(19) United States
(12) Patent Application Publication
(10) Pub. No.: US 2026/0200252 A1
(43) Pub. Date: Jul. 16, 2026

(54) CONVEYOR AND IMAGE FORMING APPARATUS

(71) Applicants: Er Sin KHOO, Kanagawa (JP); Teppei KIKUCHI, Kanagawa (JP); Hiroyuki YAMASHITA, Kanagawa (JP)

(72) Inventors: Er Sin KHOO, Kanagawa (JP); Teppei KIKUCHI, Kanagawa (JP); Hiroyuki YAMASHITA, Kanagawa (JP)

(21) Appl. No.: 19/408,419

(22) Filed: Dec. 4, 2025

(30) Foreign Application Priority Data
Jan. 14, 2025 (JP) 2025-004822

(51) Int. Cl. B41J 15/16; B41J 11/00; B41J 15/04

(52) U.S. Cl. CPC B41J 15/16; B41J 11/0005; B41J 15/046

(57) ABSTRACT

A conveyor includes a heater and a support. The heater heats a medium. The support includes a fixed base and a movable portion. The support supports the medium conveyed in a conveyance direction. The movable portion is movable between: a first position at which the movable portion is at a first distance from the fixed base in the conveyance direction; and a second position at which the movable portion is at a second distance larger than the first distance from the fixed base in the conveyance direction when the support is heated by the heater.

### CROSS-REFERENCE TO RELATED APPLICATION

This patent application is based on and claims priority pursuant to 35 U.S.C. § 119(a) to Japanese Patent Application No. 2025-004822, filed on Jan. 14, 2025, in the Japan Patent Office, the entire disclosure of which is hereby incorporated by reference herein.

### BACKGROUND

### Technical Field

The present disclosure relates to a conveyor and an image forming apparatus.

### Related Art

In the related art, an inkjet image forming apparatus (conveyor) discharges ink (liquid) onto a recording medium (medium) to form an image, and then heats and dries the ink on the recording medium by a drying device.

### SUMMARY

The present disclosure described herein provides an improved conveyor including a heater and a support. The heater heats a medium. The support includes a fixed base and a movable portion. The support supports the medium conveyed in a conveyance direction. The movable portion is movable between: a first position at which the movable portion is at a first distance from the fixed base in the conveyance direction; and a second position at which the movable portion is at a second distance larger than the first distance from the fixed base in the conveyance direction when the support is heated by the heater.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge apparatus;

FIG. 2 is a side cross-sectional view of the liquid discharge apparatus of FIG. 1;

FIG. 3 is a side cross-sectional view of a conveyor;

FIG. 4 is a side cross-sectional view of a divided platen with a movable portion positioned away from a fixed portion;

FIG. 5 is a side cross-sectional view of a platen according to a comparative example;

FIG. 6 is a side cross-sectional view of the platen of FIG. 5, which is thermally expanded;

FIG. 7 is a side cross-sectional view of a divided platen provided for a conveyor;

FIG. 8 is a side cross-sectional view of the divided platen of FIG. 7 with a fixed portion and a bimetal spring thermally expanded;

FIG. 9 is a side cross-sectional view of the divided platen of FIG. 8 with a movable portion thermally expanded;

FIG. 10 is a side cross-sectional view of a divided platen with a movable portion that moves in a moving direction different from the moving direction of the movable portion of the divided platen of FIG. 4;

FIG. 11 is a side cross-sectional view of another platen;

FIG. 12 is a side cross-sectional view of still another platen;

FIG. 13 is a side cross-sectional view of the platen of FIG. 12 with a bimetal thermally expanded;

FIG. 14 is a side cross-sectional view of the platen of FIG. 12, illustrating a state of the platen;

FIG. 15 is a schematic view of a divided platen provided with a movement mechanism;

FIG. 16 is a schematic view of the platen of FIG. 15 with a movable portion that has moved; and

FIG. 17 is a flowchart of cam control to move the movable portion of the divided platen of FIG. 15.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the related art, an inkjet image forming apparatus (conveyor) discharges ink (liquid) onto a recording medium (medium) to form an image, and then heats and dries the ink on the recording medium by a drying device. In such an image forming apparatus, when the recording medium after image formation is heated to dry the ink, a platen (support) that supports the recording medium from its back side may be heated and expanded.

In a comparative example, four members arranged in the main scanning direction construct a path member that supports a medium to be conveyed. In each member, a protrusion and a recess are slidably fitted with a gap in the main scanning direction. When the temperature of each member rises, the protrusion and the recess slide and thermally expand in a direction for filling the gap in the main scanning direction.

When the medium is heated and dried by a heater, the support thermally expands toward the medium, so that the distance between the medium and the heater becomes short, and the medium is excessively heated. As a result, the medium may be thermally deformed, and the quality of the medium after image formation may be adversely affected.

As in the comparative example, the support may be thermally expandable in the main scanning direction. However, in the configuration of the comparative example, a gap in the main scanning direction between members may cause the deterioration of the smoothness of a medium supporting surface of the support and adversely affect the conveyance of the medium.

Further, the configuration of the comparative example may not prevent thermal expansion of the support toward the medium and may not obtain a sufficient space in the main scanning direction. Accordingly, a different countermeasure is demanded.

Embodiments of the present disclosure are described below with reference to the drawings. In the drawings, like reference signs denote like elements, and overlapping descriptions may be simplified or omitted as appropriate. In the following description, a description is given of a liquid discharge apparatus that discharges ink as a liquid.

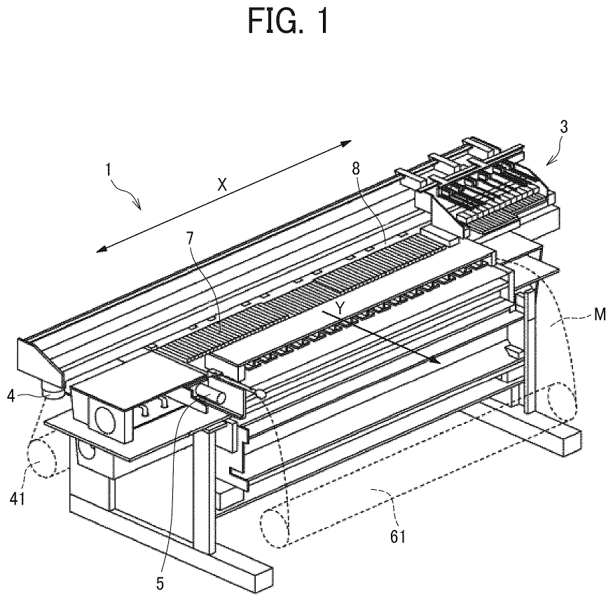

FIG. 1 illustrates a configuration of a liquid discharge apparatus 1 as an image forming apparatus. As illustrated in FIG. 1, the liquid discharge apparatus 1 includes a carriage 3, a main-scanning motor 4, a sub-scanning motor 5, a support 7, and a guide rod 8.

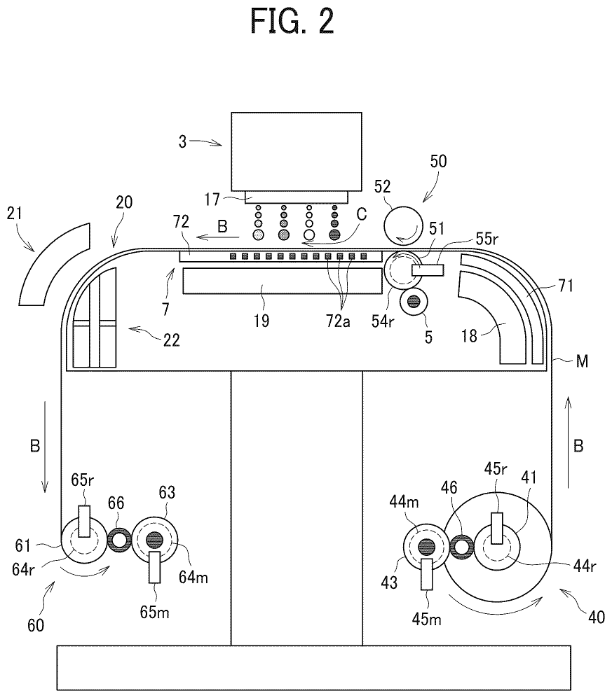

The carriage 3 includes multiple inkjet liquid discharge heads 17 (refer to FIG. 2). Each of the liquid discharge heads 17 serves as an image forming unit (device) or a liquid discharge unit (device). Each of the liquid discharge heads 17 discharges a predetermined color ink. The liquid discharge heads 17 are mounted on the carriage 3 such that the discharge faces thereof face downward. The carriage 3 is supported by the guide rod 8 extending in a main scanning direction X. Due to the driving of the main-scanning motor 4, the carriage 3 reciprocates in the main scanning direction X along the guide rod 8.

A recording medium M as a medium corresponds to an elongated printing target that is not limited in size, material, or thickness, such as a paper medium or vinyl chloride medium. The liquid discharge apparatus 1 includes a feeding roller 41 as a feeder including a feeding motor and a reeling roller 61 as a reeler including a reeling motor. The feeding roller 41 is disposed on the rear side of the liquid discharge apparatus 1 in a sub-scanning direction Y. The reeling roller 61 is disposed on the front side of the liquid discharge apparatus 1 in the sub-scanning direction Y.

The recording medium M wound around the feeding roller 41 is fed out and then is set on a platen of the support 7. A predetermined image is printed onto the recording medium M on the platen, and then the recording medium M is reeled around the reeling roller 61. In other words, by the driving force of the sub-scanning motor 5, the recording medium M is pulled out from the feeding roller 41, intermittently conveyed, and reeled around the reeling roller 61.

When the recording medium M is conveyed to a predetermined position by the driving of the sub-scanning motor 5, the conveyance of the recording medium M is temporarily stopped. Then, during the stop, the liquid discharge heads 17 discharge ink onto the recording medium M while the carriage 3 reciprocates in the main scanning direction X along the guide rod 8 by the driving of the main-scanning motor 4. Thus, an image, such as characters, a figure, a picture, or a photograph, is formed on the recording medium M.

As described above, the liquid discharge apparatus 1 serves as an inkjet printer including inkjet liquid discharge heads. The liquid discharge apparatus 1 corresponds to, for example, a serial type printer that performs printing while moving the carriage 3. The liquid discharge apparatus 1 may serve as a wide format printer, in which the carriage 3 has a long movement distance in the main scanning direction X.

As illustrated in FIG. 2, the liquid discharge apparatus 1 includes a conveyance mechanism including a feeding unit 40, a conveyance unit 50, and a reeling unit 60. The feeding unit 40 is disposed at the rear of the liquid discharge apparatus 1. The reeling unit 60 is disposed at the front of the liquid discharge apparatus 1. The conveyance unit 50 is disposed upstream from a liquid discharge position C opposed to the carriage 3 in a conveyance direction B of the recording medium M.

The conveyance direction B of the recording medium M corresponds to a direction along the surface of the recording medium M that ranges from the position at which the recording medium M is pulled out from the feeding roller 41 to the position at which the recording medium M is reeled around the reeling roller 61. In the following description, the conveyance direction B of the recording medium M may be referred to simply as a conveyance direction, and the upstream side and the downstream side in the conveyance direction may be referred to simply as the upstream side and the downstream side, respectively. A face, onto which liquid is to be discharged, of the recording medium M (upper face in FIG. 2) is referred to as an image forming face, and a face opposite the image forming face is referred to as a back face.

The support 7 includes a first platen 71, a second platen 72, and a divided platen 22. Each of these platens extends in the main scanning direction orthogonal to the surface of the paper on which FIG. 2 is drawn to support the recording medium M from the back face in the main scanning direction. The first platen 71 is disposed on the upstream side of the liquid discharge position C in the conveyance direction B of the recording medium M. The second platen 72 is opposed to the liquid discharge position C to support the recording medium M at the time of liquid discharge. The divided platen 22 is opposed to a curing heater 21 on the downstream side of the liquid discharge position C. These platens are, for example, plate-shaped components and are coupled to each other in the conveyance direction.

The first platen 71 has an arc-shaped cross section having one end directed downward and toward the feeding unit 40. The second platen 72 extends in the sub-scanning direction. The second platen 72 has small suction holes 72a at least in a printing area directly below the carriage 3 so that the recording medium M is attracted to the support 7 by a fan. Thus, the recording medium M does not float from the support 7, so that the recording medium M can be conveyed along the support 7.

A preheater 18 heats the back face of the recording medium M via the first platen 71 on the upstream side of the liquid discharge position C in the conveyance direction of the recording medium M. A platen heater 19 heats the back face of the recording medium M via the second platen 72 at the liquid discharge position C in the conveyance direction of the recording medium M.

A conveyor 20 is disposed on the downstream side of the liquid discharge position C in the conveyance direction of the recording medium M. A detailed configuration of the conveyor 20 is described later.

The feeding unit 40 includes the feeding roller 41, a feeding motor 43, encoder sheets 44r and 44m, encoder sensors 45r and 45m, and a torque limiter 46. The recording medium M is wound around the feeding roller 41. The feeding motor 43 serves as a driving source that generates tension for the recording medium M on the feeding unit 40 side. The tension applied to the recording medium M is adjusted by the torque limiter 46.

The encoder sheet 44r is attached to a rotation shaft of the feeding roller 41 to detect an amount of rotation (rotation amount) of the feeding roller 41. The encoder sensor 45r detects the remainder of the recording medium M based on the rotation amount of the feeding roller 41 detected by the encoder sheet 44r. The encoder sheet 44m is attached to the rotation shaft of the feeding motor 43 to detect a rotation amount of the feeding motor 43. The encoder sensor 45m detects the rotation speed of the feeding motor 43 based on the rotation amount of the feeding motor 43 detected by the encoder sheet 44m.

The feeding motor 43 rotates to apply force in the direction opposite to the sub-scanning direction Y, which is the conveyance direction of the recording medium M. Accordingly, tension is applied to the recording medium M held by a conveyance roller 51 and a pressure roller 52 of the conveyance unit 50, so that the torque limiter 46 of the feeding unit 40 starts slipping.

Thus, feeding tension for feeding the recording medium M is formed by the torque limiter 46 and is applied to the recording medium M. As a result, the recording medium M is fed onto the support 7 along with the rotation of the feeding roller 41. Thus, the tension between the feeding unit 40 and the conveyance unit 50 is kept constant.

The conveyance unit 50 includes the conveyance roller 51, the pressure roller 52, the sub-scanning motor 5, an encoder sheet 54r, and an encoder sensor 55r. The sub-scanning motor 5 as a conveyance motor serves as a driving source that rotates the conveyance roller 51. The pressure roller 52 is pressed against the conveyance roller 51 so as to apply pressure to the conveyance roller 51 to transfer the power of the conveyance roller 51 to the recording medium M.

The encoder sheet 54r is attached to the rotation shaft of the conveyance roller 51 to detect a rotation amount of the conveyance roller 51. The encoder sensor 55r detects the rotation speed of the conveyance roller 51 based on the rotation amount of the conveyance roller 51 detected by the encoder sheet 54r.

As the sub-scanning motor 5 rotates with the recording medium M nipped between the conveyance roller 51 and the pressure roller 52, the conveyance roller 51 rotates to convey the recording medium M in the sub-scanning direction Y.

The feeding unit 40 and the conveyance unit 50 are intermittently driven. Thus, while the carriage 3 reciprocates in the main scanning direction X by the main-scanning motor 4 described above, the recording medium M intermittently moves on the support 7.

The reeling unit 60 includes the reeling roller 61, a reeling motor 63, encoder sheets 64r and 64m, encoder sensors 65r and 65m, and a torque limiter 66. The recording medium M collected after printing is wound around the reeling roller 61. The reeling motor 63 serves as a driving source that generates tension for the recording medium M on the reeling unit 60 side. The tension applied to the recording medium M is adjusted by the torque limiter 66.

The encoder sheet 64r is attached to the rotation shaft of the reeling roller 61 to detect a rotation amount of the reeling roller 61. The encoder sensor 65r detects an amount of reeling of the recording medium M based on the rotation amount of the reeling roller 61 detected by the encoder sheet 64r. The encoder sheet 64m is attached to the rotation shaft of the reeling motor 63 to detect a rotation amount of the reeling motor 63. The encoder sensor 65m detects the rotation speed of the reeling motor 63 based on the rotation amount of the reeling motor 63 detected by the encoder sheet 64m.

As the reeling motor 63 rotates, the torque limiter 66 starts slipping. Thus, reeling tension for reeling the recording medium M is formed and applied to the recording medium M. Accordingly, the recording medium M is reeled around the reeling roller 61 along with the rotation of the reeling roller 61.

As described above, the liquid discharge apparatus 1 conveys the recording medium M by the conveyance mechanism including the feeding unit 40, the conveyance unit 50, and the reeling unit 60.

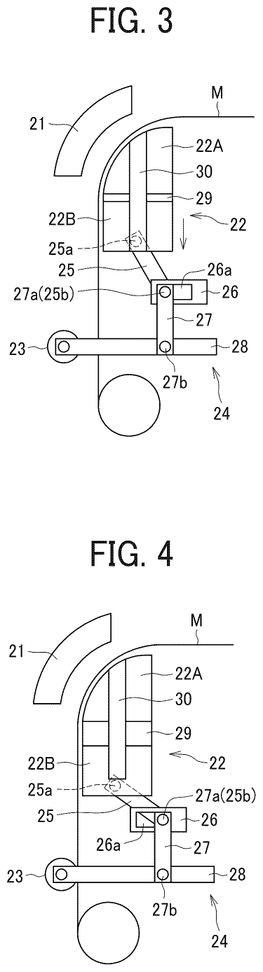

As illustrated in FIG. 3, the conveyor 20 includes the curing heater 21 as a heater, the divided platen 22 as a support, and a tension bar 23 as a pressing member. The curing heater 21 faces the image forming face of the recording medium M. The curing heater 21 heats the recording medium M after image formation to dry and cure an image formed of ink on the image forming face.

The divided platen 22 supports the back face of the recording medium M being conveyed. The divided platen 22 includes a fixed portion 22A as a fixed base, a movable portion 22B, and a bimetal spring 29 as an extendable member. The fixed base may be referred to simply as a base in the following description. The bimetal spring 29 is disposed between the fixed portion 22A and the movable portion 22B in the conveyance direction. The fixed portion 22A and the movable portion 22B have support surfaces extending along the conveyed recording medium M to support the recording medium M with the support surfaces in contact with the back face of the recording medium M. The fixed portion 22A is closer to the curing heater 21 than the movable portion 22B. For example, the fixed portion 22A and the movable portion 22B are formed of steel use stainless (SUS)304.

The fixed portion 22A and the movable portion 22B are coupled to each other by a coupler 30. In the normal state illustrated in FIG. 3, i.e., when the fixed portion 22A is not thermally expanded, the movable portion 22B is disposed adjacent to the fixed portion 22A on the downstream side in the conveyance direction of the recording medium M via the bimetal spring 29. From the state of FIG. 3, the movable portion 22B is movable toward the downstream side in the conveyance direction of the recording medium M (direction indicated by the arrow in FIG. 3). The fixed portion 22A is fixed at the position illustrated in FIG. 3.

The tension bar 23 is movable in the left-right direction in FIG. 3, which is a direction in which the tension bar 23 comes into contact with and separates from the recording medium M. The tension bar 23 reciprocates between a position separated from the recording medium M as illustrated in FIG. 3 and a position in contact with the surface of the recording medium M to press the surface of the recording medium M as illustrated in FIG. 4. In FIGS. 3 and 4, the tension bar 23 is a roller to press the outer circumferential surface of the roller against the recording medium M.

The curing heater 21 extends in a width direction (main scanning direction) of the recording medium M, which is a direction orthogonal to the surface of the paper on which FIG. 3 is drawn, to heat the recording medium M across its entire width in the width direction. The divided platen 22 extends in the width direction of the recording medium M to support the recording medium M in the width direction. The tension bar 23 extends in the width direction of the recording medium M to press the surface of the recording medium M in the width direction.

Between the movable portion 22B of the divided platen 22 and the tension bar 23, a linkage mechanism 24 that transmits the moving force of the movable portion 22B to the tension bar 23 and links the tension bar 23 with the movable portion 22B is provided. The linkage mechanism 24 includes a driven section 25, a guide member 26, a guided member 27, and a coupling section 28.

One end 25a of the driven section 25 is coupled to the movable portion 22B, and the other end 25b of the driven section 25 is coupled to one end 27a of the guided member 27. The guide member 26 has a guide hole 26a. The other end 25b of the driven section 25 and the one end 27a of the guided member 27 are coupled through the guide hole 26a so as to be movable in the guide hole 26a. The position of the guide member 26 is fixed.

The other end 27b of the guided member 27 is coupled to the coupling section 28. One end of the coupling section 28 is coupled to the tension bar 23. The guided member 27, the coupling section 28, and the tension bar 23 are fixed to each other, and integrally move along with the movement of the driven section 25 without changing the mutual positional relationship.

The conveyor 20 further conveys the recording medium M on which an image has been formed to the downstream side. Then, the curing heater 21 heats the recording medium M. At this time, the curing heater 21 also heats the divided platen 22 facing the curing heater 21 via the recording medium M. As a result, in particular, the fixed portion 22A close to the curing heater 21 and the bimetal spring 29 are heated and thermally expanded.

The fixed portion 22A and the bimetal spring 29 thermally expanded press the movable portion 22B, which is disposed adjacent to the fixed portion 22A via the bimetal spring 29, toward the downstream side in the conveyance direction of the recording medium M. As a result, as illustrated in FIG. 4, the movable portion 22B moves to the downstream side in the conveyance direction of the recording medium M with respect to the fixed portion 22A. The driven section 25 also moves along with the movement of the movable portion 22B. However, the other end 25b of the driven section 25 is restricted in a moving direction along the guide hole 26a. Accordingly, as the one end 25a of the driven section 25 moves downward in FIG. 4, the other end 25b moves to the right in FIG. 4 along the guide hole 26a. As a result, the guided member 27, the coupling section 28, and the tension bar 23 move to the right in FIG. 4. Thus, the tension bar 23 presses the surface of the recording medium M.

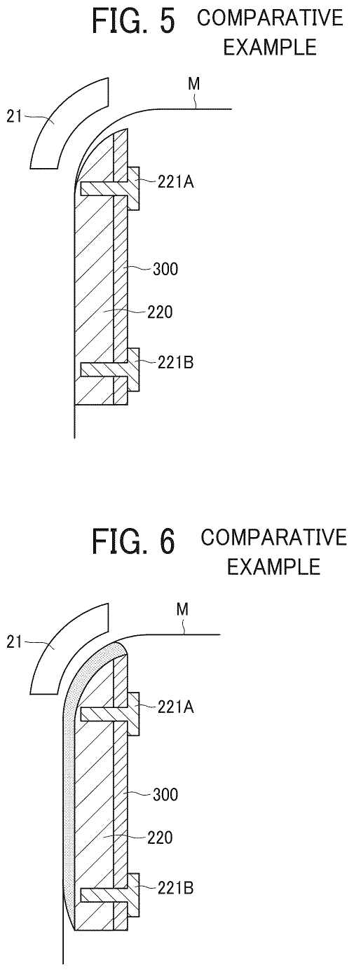

A one-piece platen 220 according to a comparative example will be described below with reference to FIGS. 5 and 6. The platen 220 illustrated in FIG. 5 is a platen having a fixed portion without a portion corresponding to the movable portion 22B. The platen 220 is coupled to a coupler 300 by fixing screws 221A and 221B on both sides in the conveyance direction. The coupler 300 is fixed to a housing (body) of the liquid discharge apparatus.

Since both sides of the platen 220 in the conveyance direction are fixed to the coupler 300 by the fixing screws 221A and 221B, the platen 220 is unlikely to thermally expand in the conveyance direction. Accordingly, as illustrated in FIG. 6, a portion of the platen 220 heated by the curing heater 21 on the support surface side supporting the recording medium M thermally expands (see the hatched portion in FIG. 6), and thus the recording medium M approaches the curing heater 21. As a result, the drying speed of the ink on the recording medium M may change, or the recording medium M may expand due to thermal expansion, and the quality of the recording medium M after image formation may deteriorate.

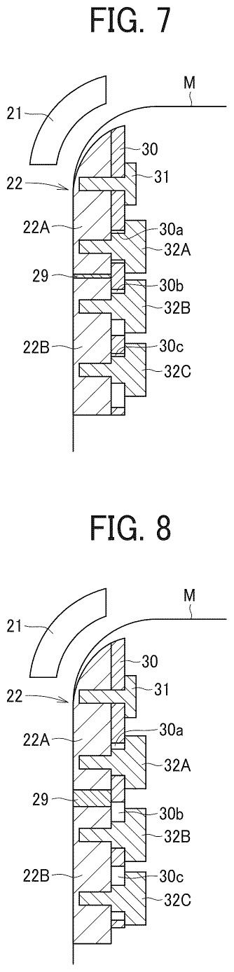

The divided platen 22 will be described below in more detail with reference to FIGS. 7 and 8. As illustrated in FIG. 7, one end of the fixed portion 22A in the conveyance direction is fixed to the coupler 30 via a fixing screw 31 as a fixing unit. A stepped screw 32A is fixed to the other end of the fixed portion 22A in the conveyance direction through a long hole 30a of the coupler 30. A stepped screw 32B is inserted into a long hole 30b of the coupler 30, passes through the long hole 30b, and is fixed to one end of the movable portion 22B in the conveyance direction. A stepped screw 32C passes through a long hole 30c of the coupler 30 and is fixed to the other end of the movable portion 22B in the conveyance direction. Thus, the coupler 30 couples the fixed portion 22A and the movable portion 22B. The coupler 30 is fixed to the housing of the body of the conveyor 20, in particular, the housing of the apparatus body of the liquid discharge apparatus, and the divided platen 22 is assembled to the housing of the apparatus body of the liquid discharge apparatus by the coupler 30 to position the divided platen 22 with respect to the apparatus body of the liquid discharge apparatus. As a result, the divided platen 22 can appropriately support the conveyed recording medium M. The stepped screws 32A to 32C are movable in the long holes 30a to 30c, respectively.

As illustrated in FIG. 8, the divided platen 22 is also heated when the curing heater 21 heats the recording medium M. At this time, the fixed portion 22A is expandable to the downstream side in the conveyance direction, which is the lower side in FIG. 8. In other words, the downstream side portion of the fixed portion 22A can thermally expand to the lower side in FIG. 7 within a range in which the stepped screw 32A can move in the long hole 30a. FIG. 8 illustrates a state in which the stepped screw 32A is disposed at the lower end of the long hole 30a and the fixed portion 22A expands to the lowest side in FIG. 8.

When the curing heater 21 heats the support 22, the fixed portion 22A and the bimetal spring 29 of the support 22 thermally expand. The fixed portion 22A and the bimetal spring 29 thermally expanded push and move the movable portion 22B toward the downstream side in the conveyance direction. As a result, the movable portion 22B moves to the downstream side in the conveyance direction with respect to the coupler 30 within a range in which the stepped screw 32B can move relative to the coupler 30 in the long hole 30b. In other words, the movable portion 22B moves in a direction away from the fixed portion 22A on the downstream side in the conveyance direction by the thermal expansion of the fixed portion 22A and the bimetal spring 29 to the downstream side in the conveyance direction. FIG. 8 illustrates a state in which the stepped screw 32B is disposed at the lower end of the long hole 30b, and the movable portion 22B has moved to the limit at the lower side in FIG. 8.

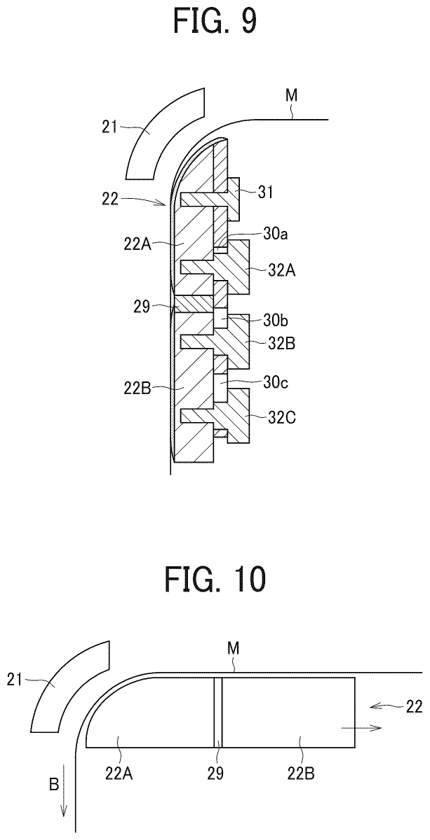

When the divided platen 22 is further heated from this state, the movable portion 22B thermally expands toward the downstream side in the conveyance direction as illustrated in FIG. 9. The movable portion 22B is thermally expandable within a range in which the stepped screw 32C can move in the long hole 30c. FIG. 9 illustrates a state in which the stepped screw 32C is disposed at the lower end of the long hole 30c and the movable portion 22B expands to the lowest side in FIG. 9.

As described above, the divided platen 22 (support) can take a first state, illustrated in FIG. 7, in which the fixed portion 22A (base) and the movable portion 22B are disposed adjacent to each other, and a second state, illustrated in FIG. 8 or 9, in which the movable portion 22B is moved in a direction away from the fixed portion 22A (base) in the conveyance direction of the recording medium M (medium) while the divided platen 22 (support) is heated. The movable portion 22B in the second state is farther away from the fixed portion 22A than the movable portion 22B in the first state. In other words, the movable portion 22B is movable between a first position at which the movable portion 22B is at a first distance from the fixed position 22A (fixed base) in the conveyance direction and a second position at which the movable portion 22B is at a second distance larger than the first distance from the fixed portion 22A (fixed base) in the conveyance direction when the divided platen 22 (support) is heated by the curing heater 21 (heater). The state in which “the base and the movable portion are disposed adjacent to each other” includes a state in which heat conduction can be performed between the fixed portion 22A (base) and the movable portion 22B directly or via another member, such as a state in which the fixed portion 22A (base) and the movable portion 22B are in direct contact with each other (i.e., when the first distance is 0) and a state in which the fixed portion 22A (base) and the movable portion 22B are continuous with another member such as the bimetal spring 29 interposed therebetween (i.e., when the first distance is more than 0), and the fixed portion 22A (base) and the movable portion 22B are not coupled, in addition to the state in which the fixed portion 22A (base) and the movable portion 22B are coupled by the coupler 30 as illustrated in FIG. 7. The term “when (while) the support is heated” refers to a state in which the temperature of the support is higher than the temperature of the support when the support is left at the environmental temperature and is not heated by the heater. In particular, the term “when the support is heated” refers to a state in which the divided platen 22 is indirectly heated by the curing heater 21 via the recording medium M.

In particular, the fixed portion 22A or the bimetal spring 29 thermally expands to the downstream side in the conveyance direction from the first state, so that the movable portion 22B is pushed, and the state of the divided platen 22 transitions to the second state in which the movable portion 22B is moved in the direction away from the fixed portion 22A (base) in the conveyance direction of the recording medium M (medium).

The fixed portion 22A and the movable portion 22B thermally expand toward the downstream side in the conveyance direction and also thermally expand toward the recording medium M side at the same time. In other words, as indicated by hatching in FIG. 9, the face of the divided platen 22 on the side supporting the recording medium M expands. However, the amount of expansion is smaller than the amount of expansion of the one-piece platen 220 illustrated in FIG. 6 due to thermal expansion of the divided platen 22 in the conveyance direction.

When the curing heater 21 stops heating, and the divided platen 22 and the bimetal spring 29 are cooled, the fixed portion 22A contracts to the upstream side in the conveyance direction, which is the side fixed to the coupler 30, and the movable portion 22B also moves to the upstream side in the conveyance direction. As a result, the state of the divided platen 22 can return to the state of FIG. 7.

As described above, the divided platen 22 (support) can take the first state and the second state. Since the divided platen 22 can transition from the first state to the second state, thermal expansion of the fixed portion 22A in the conveyance direction of the recording medium M (medium) is allowed, and thermal expansion of the divided platen 22 toward the recording medium M can be prevented. Heat can be transferred between the fixed portion 22A and the movable portion 22B directly or via another member, and the amount of heat received from the curing heater 21 can be dispersed to the fixed portion 22A and the movable portion 22B. Accordingly, for example, as compared with a configuration in which two separate platens are separately provided, the divided platen 22 can distribute the amount of heat from the curing heater 21 to reduce the temperature difference between the fixed portion 22A and the movable portion 22B, and in particular, the divided platen 22 can maintain the smoothness of the medium supporting surface of the divided platen 22 in the first state. Accordingly, for example, excessive thermal expansion of the fixed portion 22A, which is disposed on the side close to the curing heater 21, toward the recording medium M can be prevented. The phrase “the movable portion 22B is movable in the conveyance direction” does not mean that the movable portion 22B moves in strictly the same direction as the conveyance direction of the medium.

In particular, the movable portion 22B moves in the direction away from the curing heater 21. As a result, the thermal expansion of the fixed portion 22A in the conveyance direction is allowed. In addition, the amount of heat received by the movable portion 22B from the curing heater 21 can be reduced by the movement of the movable portion 22B to further prevent the thermal expansion of the movable portion 22B.

As described above, as the medium, a continuous recording medium M that is fed out from the feeding roller 41 (feeder) and reeled by the reeling roller 61 (reeler) is used (see FIG. 2). In this case, as compared with the medium separated one by one, since the medium is continuous, heat is more likely to accumulate in the recording medium M by the curing heater 21 (heater), and the support side is also more likely to be heated. Accordingly, thermal expansion of the divided platen 22 (support) toward the recording medium M is preferably prevented by applying the above-described configuration. However, the configuration described above may be applied to a conveyor that conveys the recording medium separated for each sheet.

As illustrated in FIGS. 3 and 4, the tension bar 23 (pressing member) presses the recording medium M (medium) in conjunction with the movement of the movable portion 22B. As a result, even when the recording medium M is heated and expanded by a heater such as the curing heater 21, tension can be applied to the recording medium M by the tension bar 23. Accordingly, the recording medium M can be neatly reeled without wrinkles by the reeling roller 61 without changing the reeling speed of the reeling roller 61. By lining the operation of the tension bar 23 with the movement of the movable portion 22B, the recording medium M can be tensioned by the tension bar 23, in particular, when the heating amount by the curing heater 21 (heater) increases and the thermal expansion of the fixed portion 22A increases. As described above, since the tension bar 23 can be operated in a situation where the recording medium M is likely to thermally expand, the wrinkles of the recording medium M can be efficiently removed by the tension bar 23. The configuration of the conveyor 20 can be simplified without providing a separate drive mechanism or an electrically operating mechanism such as a sensor in order to operate the tension bar 23.

The linkage mechanism 24 restricts the moving direction of the other end 25b of the driven section 25 to the direction along the guide hole 26a, so as to convert the driving force that moves the movable portion 22B in the conveyance direction (the vertical direction in FIG. 3) into the driving force that moves the tension bar 23 toward the recording medium M, which is the left-right direction in FIG. 3.

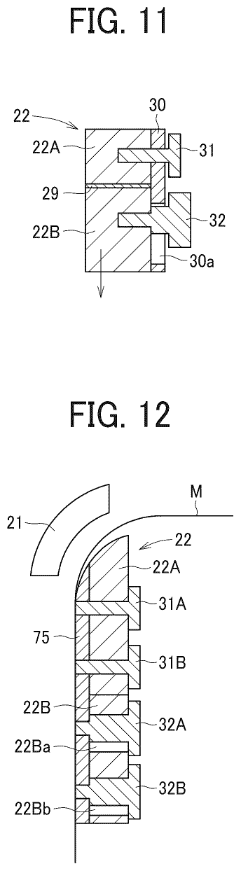

A modification of the conveyor will be described below. In the above description, the movable portion 22B moves to the downstream side in the conveyance direction of the recording medium M due to the thermal expansion of the fixed portion 22A. However, as illustrated in FIG. 10, the movable portion 22B may move to the upstream side in the conveyance direction of the recording medium M. In the divided platen 22 illustrated in FIG. 11, the fixed portion 22A is fixed to the coupler 30 by the fixing screw 31, and a stepped screw 32 is fixed to the movable portion 22B through the long hole 30a of the coupler 30. Also in this case, the stepped screw 32 moves in the long hole 30a, so that the movable portion 22B moves to the downstream side in the conveyance direction (see the direction indicated by the arrow in FIG. 11). Thus, the divided platen 22 can take the first state and the second state. Accordingly, the thermal expansion of the divided platen 22 toward the recording medium M can be prevented as in the above description.

In the embodiment illustrated in FIG. 12, the divided platen 22 is provided with a bimetal 75 extending along the fixed portion 22A and the movable portion 22B in the conveyance direction to couple the fixed portion 22A and the movable portion 22B. The bimetal 75 is an extendable member that expands by heating and contracts by cooling, and is also a coupler that couples the fixed portion 22A and the movable portion 22B in the divided platen 22. The bimetal 75 is disposed on the recording medium M side of the divided platen 22 to form the supporting surface for supporting the recording medium M. As described above, the fixed portion 22A (base) and the movable portion 22B are portions of the divided platen 22 provided integrally with the bimetal 75 having the support surface.

In FIG. 12, the fixed portion 22A is fixed to the bimetal 75 by fixing screws 31A and 31B on both sides in the conveyance direction. The stepped screw 32A is fixed to the bimetal 75 through a long hole 22Ba on the upstream side of the movable portion 22B in the conveyance direction, and the stepped screw 32B is fixed to the bimetal 75 through a long hole 22Bb on the downstream side of the movable portion 22B in the conveyance direction. FIG. 12 illustrates the first state in which the divided platen 22 is not heated by the curing heater 21, and the fixed portion 22A and the movable portion 22B are in contact (continuous) with each other (i.e., the movable portion 22B is positioned at the first position).

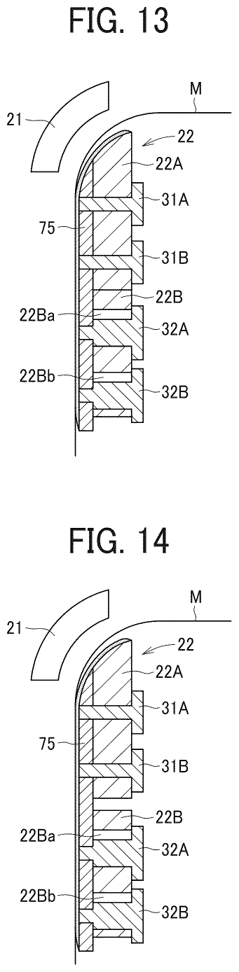

When the curing heater 21 heats the recording medium M in FIG. 12, the bimetal 75 thermally expands to the downstream side as illustrated in FIG. 13. As a result, the stepped screws 32A and 32B reach the lower ends of the long holes 22Ba and 22Bb of the movable portion 22B, respectively. When the bimetal 75 further thermally expands in this state illustrated in FIG. 13, the movable portion 22B is pushed by the bimetal 75 to move to the downstream side as illustrated in FIG. 14 to transition to the second state. Thus, the movable portion 22B is separated from the fixed portion 22A (i.e., the movable portion 22B is positioned at the second position). In addition, along with the thermal expansion of the bimetal 75, the fixed portion 22A and the movable portion 22B can thermally expand to the downstream side.

As described above, with this configuration, the divided platen 22 can take the first state and the second state, and the thermal expansion of the divided platen 22 toward the recording medium M can be prevented as in the above description.

When the curing heater 21 stops heating and the bimetal 75 contracts, the stepped screws 32A and 32B reach the upper ends of the long holes 22Ba and 22Bb of the movable portion 22B, respectively. After that, the movable portion 22B moves to the upstream side and returns to the first state illustrated in FIG. 12.

As described above, the movable portion 22B is pressed and moved in the direction away from the fixed portion 22A by the thermal expansion of the fixed portion 22A and the bimetal. However, a movement mechanism for moving the movable portion 22B may be provided.

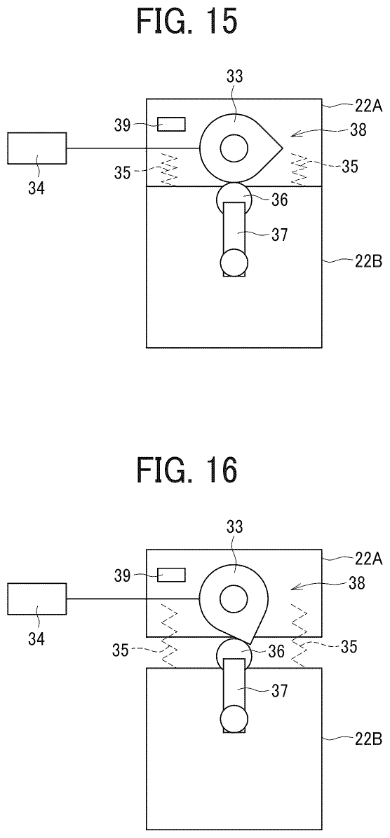

For example, as illustrated in FIG. 15, the conveyor includes a movement mechanism 38. The movement mechanism 38 includes a cam 33, a motor 34 as a driving source, springs 35 as biasing units, a contact 36, and a driven section 37. The cam 33 is attached to the fixed portion 22A of the divided platen 22. The motor 34 transmits driving force to the cam 33 to rotate the cam 33. The spring 35 has one end coupled to the fixed portion 22A and the other end coupled to the movable portion 22B to bias the movable portion 22B in the direction to approach the fixed portion 22A. The contact 36 contacts the cam 33. One end of the driven section 37 is coupled to the contact 36, and the other end of the driven section 37 is coupled to the movable portion 22B. The fixed portion 22A is provided with a temperature sensor 39 as a temperature detector that detects the temperature of the fixed portion 22A.

FIG. 15 illustrates the first state in which the fixed portion 22A and the movable portion 22B are in direct contact with each other. In this state, the small-diameter portion of the cam 33 contacts the contact 36. When the temperature detected by the temperature sensor 39 becomes equal to or higher than a predetermined threshold, i.e., when the temperature of the fixed portion 22A rises due to heating by the curing heater 21, a controller drives the motor 34 to rotate the cam 33. As a result, as illustrated in FIG. 16, the large-diameter portion of the cam 33 contacts the contact 36. Thus, the contact 36, the driven section 37, and the movable portion 22B coupled to the driven section 37 move downward in FIG. 16 against the biasing force of the springs 35. As a result, as illustrated in FIG. 16, the divided platen 22 can transition to the second state in which the movable portion 22B is moved in the direction away from the fixed portion 22A in the conveyance direction. The movable portion 22B in the second state is farther away from the fixed portion 22A than the movable portion 22B in the first state.

As described above, with this configuration, the divided platen 22 can take the first state and the second state. As a result, similarly to the above description, the thermal expansion of the fixed portion 22A toward the downstream side in the conveyance direction is allowed, and the thermal expansion of the divided platen 22 toward the recording medium M can be prevented. By driving the movement mechanism 38 based on the temperature detected by the temperature sensor 39 (temperature detector) to move the movable portion 22B, the movable portion 22B can be actively moved in the direction away from the fixed portion 22A at a more appropriate timing to transition to the second state.

When the temperature detected by the temperature sensor 39 becomes equal to or lower than the predetermined temperature, the cam 33 is rotated again to return to the position illustrated in FIG. 15. As a result, the movable portion 22B can return to the position adjacent to the fixed portion 22A by the biasing force of the springs 35 as illustrated in FIG. 15.

The tension bar 23 and the linkage mechanism 24 illustrated in FIG. 3 may be additionally installed in this configuration to move the tension bar 23 in conjunction with the movement of the movable portion 22B. The mechanism for moving the movable portion 22B is not limited to the cam 33, and may have a configuration in which the movable portion 22B is pressed to the downstream side in the conveyance direction of the recording medium, such as a pressing pin. Accordingly, the movable portion 22B can be moved by an appropriate configuration.

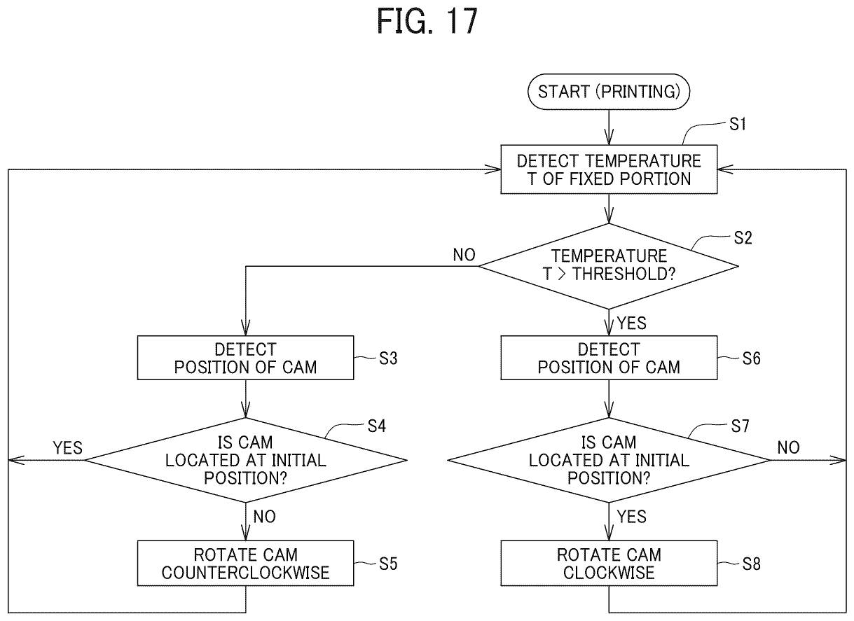

FIG. 17 is a flowchart of control of the cam 33 to move the movable portion 22B of FIG. 15. As illustrated in FIG. 17, when the printing operation is started, in step S1, the temperature sensor 39 detects the temperature of the fixed portion 22A. This detection operation by the temperature sensor 39 is continuously performed during a series of printing operations. In step S2, the controller determines whether a temperature T detected by the temperature sensor 39 exceeds a set threshold.

When the detected temperature T does not exceed the threshold, in steps S3 and S4, the position of the cam 33 is detected to determine whether the position of the cam 33 is at the initial position in FIG. 15. When the cam 33 is not at the initial position (the position in the first state), in step S5, the motor 34 drives the cam 33 to rotate the cam 33 counterclockwise from the position illustrated in FIG. 16 to the position illustrated in FIG. 15. As a result, in step S5, the movable portion 22B returns to the first state in which the movable portion 22B is positioned adjacent to the fixed portion 22A.

On the other hand, when the detected temperature T exceeds the threshold in step S2, in steps S6 and S7, the position of the cam 33 is detected to determine whether the position of the cam 33 is at the initial position in FIG. 15. When the cam 33 is at the initial position, in step S8, the motor 34 drives the cam 33 to rotate the cam 33 clockwise from the position illustrated in FIG. 15 to the position illustrated in FIG. 16. As a result, in step S8, the divided platen 22 transitions to the second state in which the movable portion 22B is moved away from the fixed portion 22A. The above operation is repeated during the printing operation. The above control causes the movement mechanism 38 to switch between the first state and the second state based on the temperature detection result of (the temperature detected by) the temperature sensor 39.

Embodiments of the present disclosure have been described as above. However, embodiments of the present disclosure are not limited to the embodiments described above, and various modifications and variations are possible within the gist of the present disclosure.

The image forming apparatus according to an embodiment of the present disclosure includes a liquid discharge apparatus including a liquid discharge head (liquid discharge device) that discharges liquid, and further includes an electrophotographic image forming apparatus. Examples of a heater installed in an electrophotographic image forming apparatus include a fixing member such as a fixing roller or a fixing belt of a fixing device. The liquid discharge apparatus may be a line head type liquid discharge apparatus, in addition to the configuration in which the carriage includes a liquid discharge head. Also in the conveyor in these image forming apparatuses, the support takes the first state and the second state to prevent thermal expansion of the support toward the medium side. The entire image forming apparatus in FIG. 1 may be referred to as a conveyor.

In the present disclosure, the liquid to be discharged is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. More specifically, examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The term “liquid” includes not only ink but also paint, a pretreatment liquid, a binder, and an overcoat liquid.

In the present disclosure, the term “liquid discharge apparatus” includes a carriage including a liquid discharge head and drives the liquid discharge head to discharge liquid. The term “liquid discharge apparatus” used herein includes, in addition to apparatuses to discharge liquid to a recording medium serving as a medium onto which liquid can adhere, apparatuses to discharge liquid into gas (air) or different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. The medium onto which liquid can adhere corresponds to the recording medium in the above embodiments. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The terms “image formation,” “recording,” “printing,” “image printing,” and “fabricating” used herein may be used synonymously with each other.

Aspects of the present disclosure are, for example, as follows.

### Aspect 1

A conveyor includes a heater that heats a medium and a support that includes a base and a movable portion and supports the medium to be conveyed. The support takes a first state in which the base and the movable portion are disposed adjacent to each other and a second state in which the movable portion is moved in a direction away from the base in a conveyance direction of the medium while the support is heated. The movable portion in the second state is farther away from the base than the movable portion in the first state.

In other words, a conveyor includes a heater and a support. The heater heats a medium. The support includes a fixed base and a movable portion. The support supports the medium conveyed in a conveyance direction. The movable portion is movable between: a first position at which the movable portion is at a first distance from the fixed base in the conveyance direction; and a second position at which the movable portion is at a second distance larger than the first distance from the fixed base in the conveyance direction when the support is heated by the heater.

### Aspect 2

The conveyor of Aspect 1 further includes a pressing member that presses a surface of the medium. The pressing member presses the medium in conjunction with movement of the movable portion in the direction away from the base.

In other words, the conveyor according to Aspect 1, further includes a pressing member to press a surface of the medium, in conjunction with a movement of the movable portion from the first position toward the second position.

### Aspect 3

In the conveyor of Aspect 2, the movable portion is coupled to the pressing member via a linkage mechanism. The linkage mechanism converts a driving force due to movement of the movable portion in the conveyance direction of the medium into a driving force of the pressing member in a direction of approaching the medium.

In other words, the conveyor according to Aspect 2, further includes a linkage mechanism linking the movable portion with the pressing member. The linkage mechanism converts a first driving force that moves the movable portion in the conveyance direction to a second driving force that moves the pressing member toward the medium.

### Aspect 4

In the conveyor of any one of Aspect 1 to Aspect 3, the movable portion is pressed and moved in the direction away from the base by thermal expansion of the support due to heating by the heater.

In other words, the heater heats the support to cause the support to: thermally expand in the conveyance direction; and push and move the movable portion from the first position toward the second position in the conveyance direction.

### Aspect 5

In the conveyor of any one of Aspect 1 to Aspect 4, the base and the movable portion are coupled by a coupler, and the base is fixed to the coupler. The movable portion moves in the direction away from the base as the movable portion moves relative to the coupler in the conveyance direction of the medium.

In other words, the conveyor according to any one of Aspects 1 to 4, further includes a coupler coupling the fixed base and the movable portion. The movable portion moves, relative to the coupler, toward the second position in the conveyance direction.

### Aspect 6

In the conveyor of Aspect 5, the coupler is fixed to a body of the conveyor.

In other words, the conveyor according to Aspect 5, further includes a body fixing the coupler to the body.

### Aspect 7

The conveyor of any one of Aspect 1 to Aspect 3, further includes a movement mechanism that moves the movable portion in the direction away from the base and a temperature detector that detects a temperature of the base. The movement mechanism moves the movable portion in the direction away from the base based on a detection result of the temperature detector.

In other words, the conveyor according to any one of Aspects 1 to 3, further includes a temperature detector to detect a temperature of the fixed base and a movement mechanism to move the movable portion from the first position toward the second position based on the temperature detected by the temperature detector.

### Aspect 8

In the conveyor of any one of Aspect 1 to Aspect 7, the medium is a continuous medium fed out from a feeder and reeled by a reeler.

In other words, the conveyor according to any one of Aspect 1 to Aspect 7, further includes a feeder to feed the medium and a reeler to reel the medium. The medium is a continuous medium.

### Aspect 9

In the conveyor of any one of Aspect 1 to Aspect 8, the movable portion moves in a direction away from the heater.

In other words, in the conveyor according to any one of Aspects 1 to 8, the movable portion moves away from the heater from the first position toward the second position.

### Aspect 10

An image forming apparatus includes the conveyor of any one of Aspect 1 to Aspect 9 and an image forming unit that forms an image on the medium.

In other words, an image forming apparatus includes an image forming unit to form an image on the medium and the conveyor according to any one of Aspects 1 to 9, to convey the medium to the image forming unit.

According to one aspect of the present disclosure, thermal expansion of the support toward the medium can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A conveyor comprising:
a heater to heat a medium; and
a support including:
a fixed base; and
a movable portion, and
the support supporting the medium conveyed in a conveyance direction,
wherein the movable portion is movable between:
a first position at which the movable portion is at a first distance from the fixed base in the conveyance direction; and
a second position at which the movable portion is at a second distance larger than the first distance from the fixed base in the conveyance direction when the support is heated by the heater.

2. The conveyor according to claim 1, further comprising a pressing member to press a surface of the medium, in conjunction with a movement of the movable portion from the first position toward the second position.

3. The conveyor according to claim 2, further comprising a linkage mechanism linking the movable portion with the pressing member,
wherein the linkage mechanism converts:
a first driving force that moves the movable portion in the conveyance direction; to
a second driving force that moves the pressing member toward the medium.

4. The conveyor according to claim 1,
wherein the heater heats the support to cause the support to:
thermally expand in the conveyance direction; and
push and move the movable portion from the first position toward the second position in the conveyance direction.

5. The conveyor according to claim 4, further comprising a coupler coupling the fixed base and the movable portion,
wherein the movable portion moves, relative to the coupler, toward the second position in the conveyance direction.

6. The conveyor according to claim 5, further comprising a body fixing the coupler to the body.

7. The conveyor according to claim 1, further comprising:
a temperature detector to detect a temperature of the fixed base; and
a movement mechanism to move the movable portion from the first position toward the second position based on the temperature detected by the temperature detector.

8. The conveyor according to claim 1, further comprising:
a feeder to feed the medium; and
a reeler to reel the medium,
wherein the medium is a continuous medium.

9. The conveyor according to claim 1,
wherein the movable portion moves away from the heater from the first position toward the second position.

10. An image forming apparatus comprising:
an image forming unit to form an image on the medium; and
the conveyor according to claim 1, to convey the medium to the image forming unit.
